(19) United States
(12) Patent Application Publication
(10) Pub. No.: US 2004/0236622 A1
(43) Pub. Date: Nov. 25, 2004

(54) Method to optimize a customer's manufacturing processes and internal business processes in a comprehensive manner

(76) Inventors: Charles A. Moyer, Royal Oak, MI (US); Todd M. Mueller, Ann Arbor, MI (US)

Correspondence Address: Larry R. Meenan, Kennametal Inc., P. O. Box 231, Latrobe, PA, 15650, US

(21) Appl. No.: 10/441,841

(22) Filed: May 20, 2003

(51) Int. Cl. G06F 17/60

(52) U.S. Cl. 705/10

(57) ABSTRACT

A method of institutionalizing technical expertise in the machine tool sector of an economy. A distributor of tooling technology enters into an agreement or arrangement with a customer which utilizes tooling technology in business operations, wherein the distributor provides expertise in exchange for which the customer satisfies tooling technology needs by purchasing from the distributor. The distributor surveys machining procedures used by the customer and improves the procedures, which are than put into practice during actual commercial operations of the customer. The improved procedures are evaluated to verify actual savings accruing from the improvements. The distributor establishes a sales force for conducting sales functions, a technical group for improving machining procedures, and an implementation specialist for managing inventory control at the customer premises. The sales force is freed from performing sales support activities outside of its area of expertise.

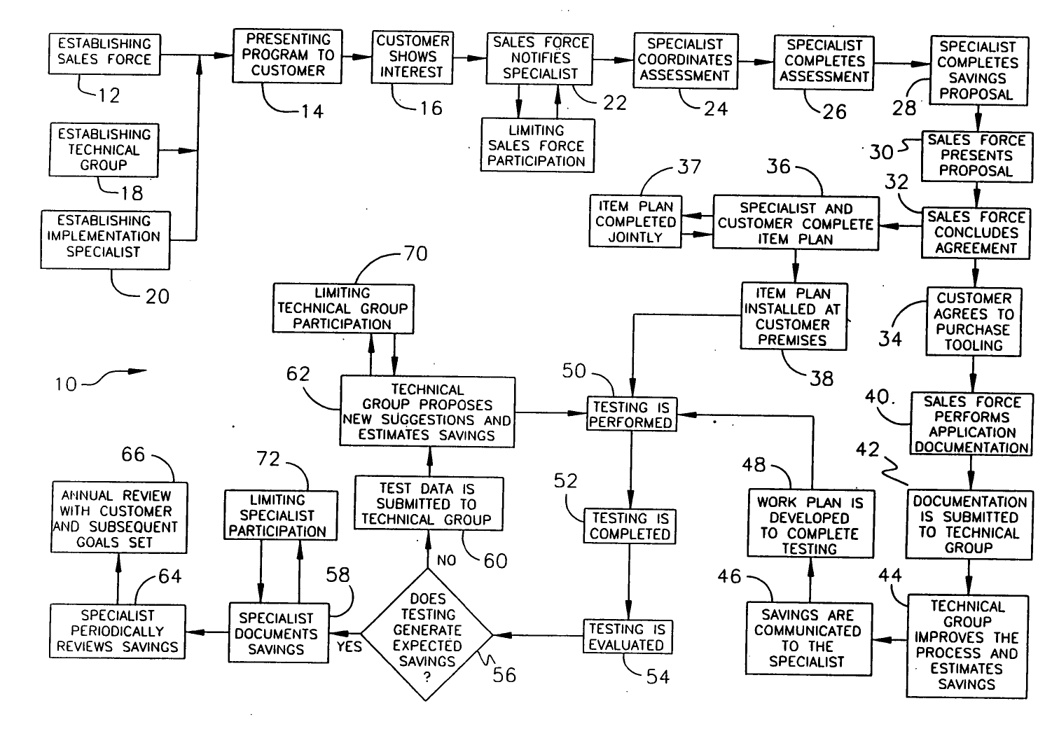

### BACKGROUND OF THE INVENTION

1. Field of the Invention

The present invention relates to a method of doing business, particularly featuring generation or modification of a manufacturing procedure by a machine tool equipment distributor for a manufacturer using the manufacturing procedure in commercial operations.

2. Description of the Related Art

The machine tool industry is one that requires great expertise in the use of tooling hardware, such as cutting tools, end mills, inserts, and the like. Although tooling hardware may be purchased from many sources, it is no easy task to make optimal selections and to employ tooling hardware optimally for long term productivity. Because of the difficulties in knowing which tooling hardware products and associated procedures are appropriate in any given machining application, consumers of tooling hardware are heavily reliant upon industry experts in making purchasing decisions.

It therefore behooves distributors of tooling technology to make expertise available to tooling consuming customers. Such customers become dependent upon the most accessible expertise available in making purchases relating to and even in optimally utilizing their tooling needs.

The tooling industry is quite fragmented in that there are many distributors with no single distributor or identifiable group of distributors dominating the market. It is estimated that even the leading distributor has only about a two percent market share in the United States. It simply is very difficult for a machine tool customer to make highly informed purchasing decisions in this market. It is possible that one field sales representative has technical expertise to guide a purchaser of tooling, but that another sales representative of a competitor or even of the same distributor does not.

Providing a customer with expertise in selection and usage of technology has long been a sales tool employed by industrial distributors. It is also known to predicate sales efforts based on identifying savings that may result from particular purchasing and usage decisions. However, there remains a need within the highly specialized and fragmented machine tool environment for making technical expertise predictably available to the machine tool consuming sector of the economy.

### SUMMARY OF THE INVENTION

The present invention sets forth a business method of making technical expertise of a tooling technology distributor available to present and potential customers of tooling technology within the machine tool sector of the economy. This is accomplished in a cooperative, symbiotic relationship uniting a tooling technology distributor and a present or potential customer. The method includes an arrangement based on the distributor providing technical expertise as well as tooling technology, while the customer commits to purchasing tooling technology from the distributor. Once the arrangement is established, the distributor makes technical improvements to the customer's prior or contemplated processes. These improvements are implemented at the premises of the customer, with long term, ongoing evaluations based on real world testing of tooling technology preferably performed during actual commercial operations of the customer, to assure that contemplated results are actually obtained. Also, economic benefits accruing from the technical expertise are particularly pointed out to the customer. This is done in the course of evaluating, as well as merely as part of an initial sales effort to persuade the customer to enter into such an arrangement. Preferably, economic savings periodically evaluated by the distributor, with the results being reviewed by the customer. Illustratively, at the end of a manufacturing cycle, which could be optionally one year in duration, subsequent economic goals are set after economic review.

The customer benefits from greatly enhanced productivity by drawing upon the expertise of the distributor. The distributor efficiently brings expertise of several in-house specialists who offer different yet complementing aspects of expertise, in a manner which economizes in the utilization of the time of these specialists. This makes possible commitment by the distributor of expertise without the economic necessity of charging specifically for the consultation.

A significant aspect of the novel method is that it institutionalizes the formerly haphazard application of expertise in making available technical consultants to customers of tooling technology. This provides significant reassurances to customers, and enhances the standing and sales potential of a distributor of tooling technology.

It is therefore a feature of the invention to make technological expertise available to tooling customers on an organized, predictable basis in order to optimize manufacturing processes which utilize tooling technology and related business practices of the customer.

It is another feature of the invention to assure that both the tooling customer and a tooling distributor engage in a symbiotic ongoing relationship.

### BRIEF DESCRIPTION OF THE DRAWINGS

Various other features and attendant advantages of the present invention will become more fully appreciated as the same becomes better understood when considered in conjunction with the accompanying drawing, which is a ladder diagram of steps of performing the novel method. The diagram is read starting from the upper left and proceeding generally in a clockwise direction, following the arrowheads.

### DESCRIPTION OF THE PREFERRED EMBODIMENT

A preferred embodiment of the novel method 10 is shown as a series of steps in the drawing. The concept of doing business between a customer of tooling technology and a distributor of tooling technology, wherein the distributor supplies tooling technology to be utilized in a manufacturing process practiced by the customer in the course of manufacturing, is initiated by the distributor. The distributor establishes a sales force in a step 12. In step 14, the contemplated collaboration, which is hereinafter referred to as the program, is presented to the customer. The distributor is a wholesale distributor supplying industrial customers, a manufacturer of tooling technology which sells its products to customers, an efficiency consultant providing consulting services to customers, any party otherwise commercially related to tooling technology, or any combination of these. The customer is any commercial or institutional organization which utilizes tooling technology to produce partially finished or fully finished workpieces fabricated by machining and related material handling techniques. Tooling technology will be understood to encompass software, tooling hardware, and manufacturing methods, making selections from standard catalog products, innovating new products, and combinations of all of these components. Machining will be understood to include boring, milling, ramping, plunging, and all manner of shaping of work pieces by removing constituent material by a tool which moves relatively to and is brought to bear against the work pieces.

It will be understood that as is conventionally practiced by commercial distributors of industrial goods and services, the distributor has established a sales force of at least one person. Typically, the sales force for large scale distributors serving at a minimum several regions of a country and also including distributors serving at least one and often a number of countries includes at least one sales representative for each region. The sales representative is a specialist in his own way, having expertise in conducting sales presentations with a customer and to conduct financial negotiations with potential and actual customers, culminating in concluding commercial arrangements or agreements. Of course, the sales force is not limited to these areas of expertise. In step 16, the customer expresses interest. The sales representative then notifies others within the distributor organization.

A brief understanding of the role of various distributor personnel will better explain the novel method. A significant element of the invention is to optimize use of the personnel of the distributor by suitable division of labor. To this end, sales functions are reserved for the sales force, and technical recommendations are made by a technical group of at least one expert in machining technology, which has been established by the distributor in step 18. Although these two groups intercommunicate, each performs its functions independently of the other. There is an optional third group, which plays a role in preferred embodiments of the invention. The third group comprises at least one implementation specialist who implements improvements to the manufacturing process and optionally yet preferably installs, manages, and maintains inventory at the facilities of the customer.

In the machine tool industry, tooling technology distributors have provided certain goods and services the function of which is to oversee inventory within a customer's manufacturing premises of certain tools and supplies which are utilized and depleted on a regular or predictable basis. An example of this is ToolBoss (a registered trademark of Kennametal Inc.), a product of Kennametal Inc., of Latrobe, Pa. ToolBoss provides cabinetry having drawers for storing supplies for use, such as inserts for cutting, boring, and shaping tools, as well as other tools and supplies. ToolBoss includes software for tracking the identity of specific tools and materials, their location within the cabinetry, the actual count of each, their minimum and maximum inventory levels, and optionally other characteristics of the inventory. The distributor establishes the position of implementation specialist in step 20 to oversee inventory management potentially independently from participation in the novel method.

With the foregoing in mind, the sales force has notified others within their distributor organization of interest by the customer. In the preferred embodiment, and as shown in step 22, this party is the implementation specialist, who is designated “specialist” for brevity. The specialist then coordinates or performs an initial assessment of customer operations, as shown in step 24. This assessment can take the form of a questionnaire completed jointly with the customer. The assessment determines the scale of the customer's operation, which will subsequently be used to estimate advantages of inventory control, and to support a decision made by the customer to participate in the program, which is the subject of the invention. The assessment is completed in step 26, regardless of the actual form of the assessment.

Referring back to step 18, the distributor has also established a technical expertise group the primary function of which is to design possible modifications to manufacturing processes, which utilize tooling technology for machining. The technical expertise group, which will be referred to as the technical group hereinafter for brevity, actually generates an improved manufacturing process by introducing changes and improvements thereto.

The distributor then completes an initial proposal containing a preliminary savings estimate, shown as step 28. The sales force presents this proposal to the customer in step 30. A contractual arrangement or agreement may be entered into with the customer, shown as step 32. In its essence, the arrangement or agreement calls for the distributor to incorporate modifications proposed at least in part by the distributor to a manufacturing process which is contemplated to be used in the future by the customer, in exchange for compensation which will accrue to the distributor. Although compensation can take many forms, it is preferred that the compensation take the form of having the customer agree to purchase tooling technology relating to the improved manufacturing process from the distributor, shown as step 34. This tooling technology is, of course, commercially available from the distributor. Efficiencies arising from the novel method enable the distributor to render a valuable service as a consultant without demanding separate compensation as a consultant, relying for compensation instead on increased sales.

The method then potentially proceeds along two parallel paths. Should the customer not already have incorporated an at least partially automated inventory control program, or to replace an existing program with a more useful or extensive program, such a program is optionally yet preferably implemented. In step 36, the specialist and the customer work together to develop an item plan which lists tooling which will be managed by the specialist for a new manufacturing process, or alternatively is being installed for the first time to the customer's operations. In step 38, the new or revised item plan is installed at the customer's manufacturing premises.

Concurrently and independently, and referring to step 40, the distributor, preferably acting through the sales force, documents the nature of the manufacturing process which is to be improved. Documentation establishes a record of parameters of the subject manufacturing process, upon which documentation the distributor experts will base their recommendations for improvements. Preferably, this documentation is performed by the sales force, although others could perform this function if desired. In a step 42, this documentation is submitted to the technical group for their analysis and suggested improvements. The technical group then identifies possible modifications, suggests appropriate improvements by incorporating revised tooling technology into the manufacturing process, thereby generating an improved manufacturing process, and estimates resultant savings, shown as step 44.

The improved manufacturing process is then communicated to the implementation specialist for implementation at the customer premises, shown as step 46. In step 48, a work plan is then developed to enable testing of the improved manufacturing process. Testing is then performed based on the work plan, seen as step 50. Preferably, testing is accomplished as part of under actual commercial manufacturing operations of the customer, although other testing may be employed if desired. In step 50, the technical group coordinates testing with the specialist and with the manufacturer of the tooling technology, which has been introduced into the improved manufacturing process. Tool testing conducted at the customer premises is completed in step 52.

Upon completion of testing, test results are evaluated in light of expectations in a step 54. Preferably, evaluation is conducted entirely by the specialist or any personnel of the distributor. This is followed by a further step 56 of making a decision pursuant to evaluation wherein achievement of expected economic savings is followed by a step 58 of documenting achievement of expected economic savings and presenting documented savings to the customer, and failure to achieve expected economic savings is followed by steps 60 and 62, and repetition of steps 50, 52, and 54. Step 60 is practiced wherein test data is submitted to the technical group for further review. Subsequent to step 60 is step 62 in which the technical group proposes new suggestions to be implemented and tested. Savings from the new suggestions are estimated in step 62. The new suggestions are implemented, retested, and re-evaluated, repeating steps 50, 52, 54, and 56.

In a step 64, the specialist periodically reviews savings which had initially been documented in step 58. The distributor then conducts a periodic review with the customer, such as illustratively an annual review, and sets subsequent goals for the future, as shown in step 66.

It would be possible to exclude the role of the specialist from the method as described above. The functions formerly performed by the specialist would be performed instead by members of the technical specialists, by others not part of the technical specialists, or by both. It would be preferable, however, to preclude the sales force from such a role. Even where the specialist is present, it is desirable to implement a division of labor wherein the specialist substantially avoids participation in sales activities such as conducting sales presentations and in conducting financial negotiations, and avoids participation in making technical improvements in machining or tooling operations. On the other hand, it is desirable to have the specialist establish and oversee management at the premises of the customer an at least partially automated inventory control program, which maintains statistical control of stocking levels of elements of tooling technology. At a minimum, the specialist develops automated listing of tooling to be employed by the customer in the course of manufacturing.

In a similar vein, and to implement the desired division of labor of the distributor personnel, the sales force substantially avoids participation in designing modifications to the manufacturing process being improved. Preferably, the technical group substantially avoids participation in conducting sales presentations and in conducting financial negotiations.

Limiting of sales force participation in the novel method is shown as a step 68; limiting of technical group participation is shown as a step 70; and limiting of specialist participation is shown as a step 72.

The order of the steps of the novel method may be varied from that in which they are presented herein, as long as the order assures that the end results of the method as described would still be obtainable.

The documents, patents and patent applications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit.

What is claimed is:

1. A method of doing business between a customer of tooling technology and a distributor of tooling technology, wherein the distributor supplies tooling technology to be utilized in a manufacturing process practiced by the customer in the course of manufacturing, comprising the steps of:
conducting an assessment of the manufacturing process;
identifying possible modifications to the manufacturing process and identifying estimated savings associated with the possible modifications, responsive to the step of conducting an assessment;
generating a commercial arrangement between the customer and the distributor to incorporate modifications proposed at least in part by the distributor to a contemplated manufacturing process which is contemplated to be used in the future by the customer, in exchange for compensation which will accrue to the distributor;
generating an improved manufacturing process wherein the distributor modifies the contemplated manufacturing process by incorporating revised tooling technology in the contemplated manufacturing process;
implementing the improved manufacturing process at the premises of the customer; and
evaluating the improved manufacturing process to determine whether expected economic savings will be realized.

2. The method according to claim 1, wherein the step of generating an arrangement between the customer and the distributor comprises the further step of making the compensation take the form of having the customer agree to purchase from the distributor tooling technology relating to the improved manufacturing process.

3. The method according to claim 2, comprising the further steps of
having the distributor establish a sales force the primary function of which is to conduct sales presentations with the customer and to conduct financial negotiations;
having the distributor establish a technical expertise group the primary function of which is to design the possible modifications to the manufacturing process;
having the technical expertise group generate the improved manufacturing process;
having the sales force substantially avoid participation in designing the possible modifications; and
having the technical expertise group substantially avoid participation in conducting sales presentations and in conducting financial negotiations.

4. The method according to claim 3, wherein the step of generating an improved manufacturing process comprises the further step of having the sales force document current manufacturing practices of the customer for subsequent review by the technical expertise group.

5. The method according to claim 1, comprising the further steps of
establishing at the premises of the customer an at least partially automated inventory control program which maintains statistical control of stocking levels of elements of the tooling technology; and
having the distributor establish an implementation specialist the functions of whom are to oversee installation and management of the automated inventory control program.

6. The method according to claim 5, comprising the further steps of
having the implementation specialist substantially avoid participation in designing the possible modifications, in conducting sales presentations, and in conducting financial negotiations; and
having the implementation specialist develop automated listing of tooling to be employed by the customer in the course of manufacturing as part of the step of establishing at the premises of the customer an at least partially automated inventory control program.

7. The method according to claim 6, wherein the step of having the implementation specialist develop automated listing of tooling includes the further step of having the implementation specialist and the customer jointly develop automated listing of tooling.

8. The method according to claim 1, wherein the step of identifying estimated savings comprises the further step of having identification of savings conducted entirely by the distributor.

9. The method according to claim 1, wherein the step of evaluating test results to determine whether expected economic savings will be realized comprises the further step of having the distributor analyze test results.

10. The method according to claim 1, wherein the step of evaluating test results includes a further step of making a decision pursuant to evaluation, wherein
achievement of expected economic savings is followed by a step of documenting achievement of expected economic savings and presenting documented savings to the customer, and
failure to achieve expected economic savings is followed by a step of performing further technical review, further technical modification of the improved manufacturing process, further testing, and further economic evaluation of test results.

11. The method according to claim 10, wherein the step of evaluating test results to determine whether expected economic savings will be realized is followed by a step of periodically evaluating savings achieved by the improved manufacturing process.

12. The method according to claim 11, comprising a further step of setting subsequent goals for the future.
